(19) United States
(12) Patent Application Publication
(10) Pub. No.: US 2026/0065592 A1
(43) Pub. Date: Mar. 5, 2026

(54) APPARATUS AND METHOD FOR GENERATING STANDARDIZED 3D OBJECTS BASED ON SATELLITE IMAGERY

(71) Applicant: NAVIWORKS CO., LTD., Anyang-si (KR)

(72) Inventors: Hyo Sang KUK, Anyang-si (KR); Seo Ung CHOI, Anyang-si (KR)

(21) Appl. No.: 19/311,653

(22) Filed: Aug. 27, 2025

(30) Foreign Application Priority Data
Aug. 30, 2024 (KR) 10-2024-0117862

(51) Int. Cl. G06T 17/05; G06T 3/4046; G06T 7/11; G06T 7/13; G06T 15/04; G06T 17/20

(52) U.S. Cl. CPC G06T 17/05; G06T 3/4046; G06T 7/11; G06T 7/13; G06T 15/04; G06T 17/20; G06T 2200/08; G06T 2207/10032; G06T 2207/20084; G06T 2207/30184

(57) ABSTRACT

The present disclosure relates to an apparatus and a method for generating standardized 3D objects based on satellite imagery. An apparatus for generating standardized 3D objects based on satellite imagery according to one embodiment of the present disclosure may include a preprocessing unit configured to preprocess the satellite imagery by upscaling the satellite imagery using a generative adversarial network (GAN), and then resizing and dividing the upscaled satellite imagery, a digital surface model generation unit configured to generate a digital surface model for the preprocessed satellite imagery by applying a vision transformer to the preprocessed satellite imagery, an object boundary information generation unit configured to generate boundary information of individual objects included in the preprocessed satellite imagery using a convolutional neural network (CNN)

### CROSS-REFERENCE TO RELATED APPLICATION

This present application claims the benefit of priority to Korean Patent Application No. 10-2024-0117862, filed on Aug. 30, 2024, in the Korean Intellectual Property Office, the entire disclosure of which is incorporated herein by reference.

### FIELD

The present disclosure relates to an apparatus and a method for generating standardized objects based on satellite imagery, and more particularly, to an apparatus and a method for generating standardized 3D models of objects in satellite imagery.

### BACKGROUND

To arrange and test objects such as buildings and vegetation in a user-friendly manner, 3D models—such as 3D building and vegetation models based on real-world environments—may be required.

In existing techniques, such 3D models may be typically generated using pre-extracted and classified vector data obtained from LiDAR or high-precision road maps. However, these approaches may rely on the pre-extracted and classified vector data, and therefore may not accurately reflect dynamic real-world environments or the variety of object types.

Furthermore, technologies that generate 3D models from high-resolution maps may often require additional data beyond the maps themselves—such as multi-layered geospatial data, satellite imaging conditions, and digital surface models—which makes it difficult to secure all the necessary data for generating 3D models. As a result, even organizations or companies that possess high-resolution maps may face difficulties in generating suitable and user-friendly 3D objects from those maps.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

The present disclosure is directed to providing an apparatus and a method for generating standardized 3D objects based on satellite imagery, which may generate 3D models in a predefined standard format using only images obtained through OGC standard web services or provided by users, without requiring any additional auxiliary data.

Aspects of the present disclosure are not limited to those mentioned above, and other aspects and advantages not mentioned above will be understood from the following description, and become more apparent from the exemplary embodiments. Moreover, aspects of the present disclosure may be realized by the means and combinations thereof indicated in claims.

An aspect of the present disclosure may provide an apparatus for generating standardized 3D objects based on satellite imagery, the apparatus including a preprocessing unit configured to preprocess the satellite imagery by upscaling the satellite imagery using a generative adversarial network (GAN), and then resizing and dividing the upscaled satellite imagery, a digital surface model generation unit configured to generate a digital surface model for the preprocessed satellite imagery by applying a vision transformer to the preprocessed satellite imagery, an object boundary information generation unit configured to generate boundary information of individual objects included in the preprocessed satellite imagery using a convolutional neural network (CNN), and a processing unit configured to generate digital surface models for one or more individual objects included in the preprocessed satellite imagery by combining the digital surface model for the preprocessed satellite imagery with the boundary information of individual objects, and to generate a clustered object digital surface model by integrating the digital surface models for the one or more individual objects.

The apparatus may further include a 3D mesh generation unit configured to generate a 3D mesh by vectorizing the clustered object digital surface model, and an output unit configured to output the 3D mesh in a predefined standardized format.

The apparatus may further include a visualization unit configured to visualize the 3D mesh, wherein, when the object is a building, a top surface texture of the building in the 3D mesh is generated using satellite imagery of the building, and a side surface texture of the building is generated by extracting a color from the top surface texture.

Another aspect of the present disclosure may provide a method for generating standardized 3D objects based on satellite imagery, the method including preprocessing the satellite imagery by upscaling the satellite imagery using a generative adversarial network (GAN), and then resizing and dividing the upscaled satellite imagery, generating a digital surface model for the preprocessed satellite imagery by applying a vision transformer to the preprocessed satellite imagery, generating boundary information of individual objects included in the preprocessed satellite imagery using a convolutional neural network (CNN), and generating digital surface models for one or more individual objects included in the preprocessed satellite imagery by combining the digital surface model for the preprocessed satellite imagery with the boundary information of individual objects, and generating a clustered object digital surface model by integrating the digital surface models for the one or more individual objects.

The method may further include generating a 3D mesh by vectorizing the clustered object digital surface model, and outputting the 3D mesh in a predefined standardized format.

The method may further include visualizing the 3D mesh, wherein, when the object is a building, a top surface texture of the building in the 3D mesh is generated using satellite imagery of the building, and a side surface texture of the building is generated by extracting a color from the top surface texture.

According to embodiments of the present disclosure, 3D objects may be automatically generated from images input through satellite imagery or OGC-standard web services such as WMTS, and the generated 3D objects may be used as predefined standardized 3D models.

In addition, according to embodiments of the present disclosure, 3D objects may be generated from updated satellite imagery, and changes in the 3D objects may be identified by comparing them with 3D objects generated prior to the update.

Further, according to embodiments of the present disclosure, when the satellite imagery is of low resolution, the imagery may be converted into high-resolution imagery to generate high-quality 3D objects.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a block diagram illustrating an apparatus for generating standardized 3D objects based on satellite imagery according to one embodiment of the present disclosure.

FIG. 2 is a flowchart illustrating a method for generating standardized 3D objects based on satellite imagery according to one embodiment of the present disclosure.

FIG. 3 is a diagram illustrating an example of satellite imagery according to one embodiment of the present disclosure.

FIG. 4 is a diagram illustrating an example of an image in which object boundaries are extracted according to one embodiment of the present disclosure.

FIG. 5 is a diagram illustrating an example of a clustered object digital surface model according to one embodiment of the present disclosure.

FIG. 6 is a diagram illustrating an example output according to one embodiment of the present disclosure.

FIG. 7 is a diagram illustrating a computing system according to one embodiment of the present disclosure.

### DETAILED DESCRIPTION

Hereinafter, exemplary embodiments disclosed in the present document will be described in detail with reference to the accompanying drawings. Like reference numerals designate like elements, and redundant descriptions thereof will be omitted. Further, such as “module” and a “unit”, suffixes for components used in the following description are given or mixed and used by considering easiness in preparing a specification and do not have a meaning or role distinguished from each other in themselves. In addition, in describing an embodiment disclosed in the present document, if it is determined that a detailed description of a related art incorporated herein unnecessarily obscure the gist of the embodiment, the detailed description thereof will be omitted. Furthermore, it should be understood that the appended drawings are intended only to help understand embodiments disclosed in the present document and do not limit the technical principles and scope of the present disclosure; rather, it should be understood that the appended drawings include all of the modifications, equivalents or substitutes described by the technical principles and belonging to the technical scope of the present disclosure.

Although the terms first, second, and the like, may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

Unless otherwise defined, all technical and scientific terms used in the present disclosure have the same meanings as commonly understood by those skilled in the art of this application. The terms “include,” “comprise,” and any variations thereof used in the specification of this application are intended to encompass non-exclusive inclusion.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

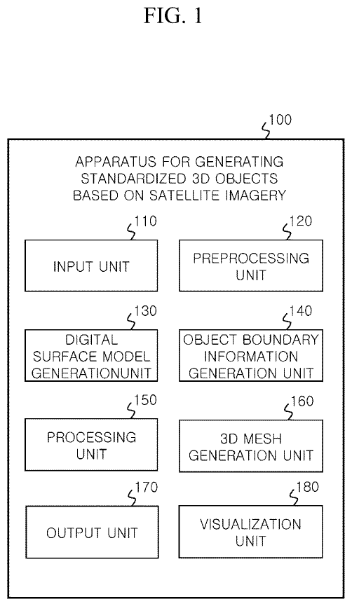

Hereinafter, an apparatus and method for generating standardized 3D objects based on satellite imagery according to the present disclosure will be described in detail with reference to FIGS. 1 to 7.

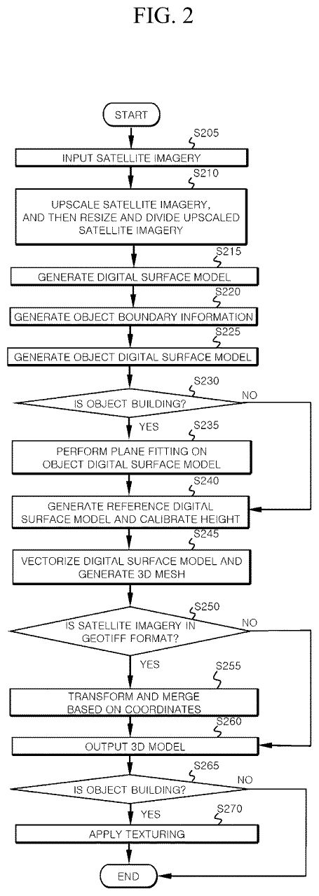

FIG. 1 is a block diagram illustrating an apparatus for generating standardized 3D objects based on satellite imagery according to one embodiment of the present disclosure, and FIG. 2 is a flowchart illustrating a method for generating standardized 3D objects based on satellite imagery according to one embodiment of the present disclosure.

Referring to FIG. 1, an apparatus 100 for generating standardized 3D objects based on satellite imagery according to one embodiment of the present disclosure may include an input unit 110, a preprocessing unit 120, a digital surface model generation unit 130, an object boundary information generation unit 140, a processing unit 150, a 3D mesh generation unit 160, an output unit 170, and a visualization unit 180.

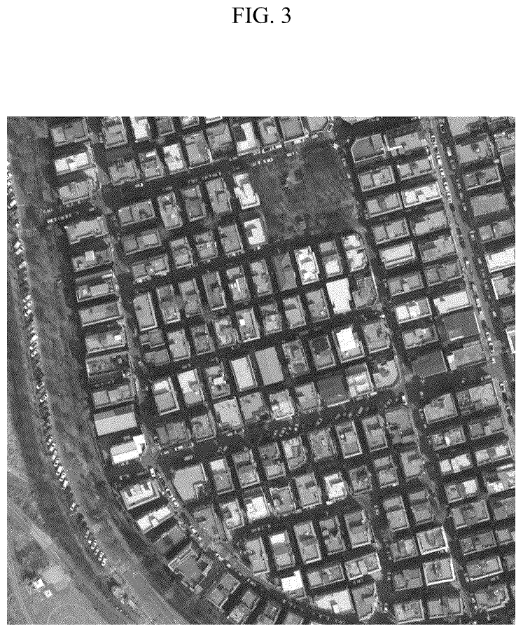

The input unit 110 may be configured to receive satellite imagery provided by a user and to transmit the received imagery to the preprocessing unit 120 (see S205). The satellite imagery (see FIG. 3) may be obtained through various means, such as a local file system, a scanner or camera, OGC standard web services such as WMTS and WMS, or APIs.

The preprocessing unit 120 may be configured to perform preprocessing by upscaling satellite imagery using a GAN, and then resizing and dividing the upscaled satellite imagery (see S210).

Specifically, the GAN used in the preprocessing unit 120 may be a model in which two neural networks—a generator and a discriminator—are trained in an adversarial manner by competing with each other. When the generator produces realistic images that may deceive the discriminator, the discriminator may be trained to better distinguish between the generated images and real ones. To use the GAN for upscaling, a dataset of paired high-resolution images and corresponding low-resolution images is prepared. The generator network is trained to generate high-resolution images from the low-resolution inputs, while the discriminator network is trained to distinguish between the generated high-resolution images and real high-resolution images. The GAN model according to one embodiment of the present disclosure may be a model generated to enable upscaling of low-resolution satellite imagery by learning from a dataset consisting of pairs of high-resolution satellite imagery and low-resolution satellite imagery. Additionally, the GAN model may be an existing model such as SRGAN (Super-Resolution Generative Adversarial Networks) or ESRGAN (Enhanced Super-Resolution Generative Adversarial Networks). Furthermore, the GAN model may be a model obtained by additionally training an existing model with a dataset consisting of pairs of high-resolution satellite imagery and low-resolution satellite imagery.

The preprocessing unit 120 may also be configured to resize the satellite imagery and divide it into multiple segments so that a deep learning model may process the imagery.

The digital surface model generation unit 130 may be configured to generate a digital surface model for the preprocessed satellite imagery by applying a vision transformer to the preprocessed satellite imagery (see S215).

Specifically, the digital surface model may be three-dimensional terrain data that may include height information of all objects. The digital surface model may include not only terrain elevation but also the height of man-made and natural objects, such as buildings, trees, and bridges.

Specifically, the vision transformer used in the digital surface model generation unit 130 may be a deep learning model that employs a transformer architecture for processing images. The vision transformer may utilize an attention mechanism to effectively capture the relationships among input data. The vision transformer may divide an input image into patches of a fixed size, and go through processes such as patch embedding, positional encoding, and transformer encoding to generate feature representations that contain information about respective regions of the image. A transformer encoder may then be configured to learn contextual relationships among the patches and to generate feature representations, which include semantic information corresponding to respective regions of the image. The vision transformer according to one embodiment of the present invention may be a model trained on satellite imagery and corresponding digital surface model datasets.

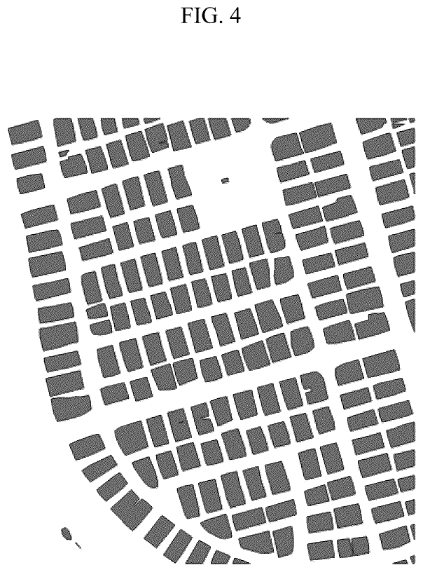

The object boundary information generation unit 140 may be configured to generate boundary information of individual objects (see FIG. 4) included in the preprocessed satellite imagery using a CNN (see S220).

Preferably, the CNN may use a UResNet model. Specifically, the UResNet model may be a deep learning model that combines a U-Net architecture and a ResNet architecture, and may be configured to perform image segmentation. U-Net is a model used for segmentation that may downsample input images to extract feature maps, then upsample them back to the original resolution while combining corresponding feature maps from both paths to improve segmentation accuracy. Specifically, the ResNet may be a deep learning model that uses a residual connection technique, also referred to as a skip connection, in which an arbitrary layer among deep learning layers is bypassed so that its input is directly forwarded to a deeper layer, and may address the vanishing gradient problem and stably train deeper networks. The UResNet model according to one embodiment of the present disclosure may be a model trained through processes such as data augmentation, preprocessing, and loss function optimization using a high-quality satellite image dataset annotated with building boundary information.

In addition, the object boundary information generation unit 140 may be configured to extract objects from the image based on polygons rather than on a pixel basis, and to accurately distinguish object boundaries without noise.

Specifically, the object boundary information generation unit 140 may be configured to train the UResNet model to generate polygon labels corresponding to building boundaries from digital surface model data through processes such as data augmentation, preprocessing, and loss function optimization, and may be configured to allow the UResNet to perform polygon-based segmentation when extracting building boundary information from satellite imagery.

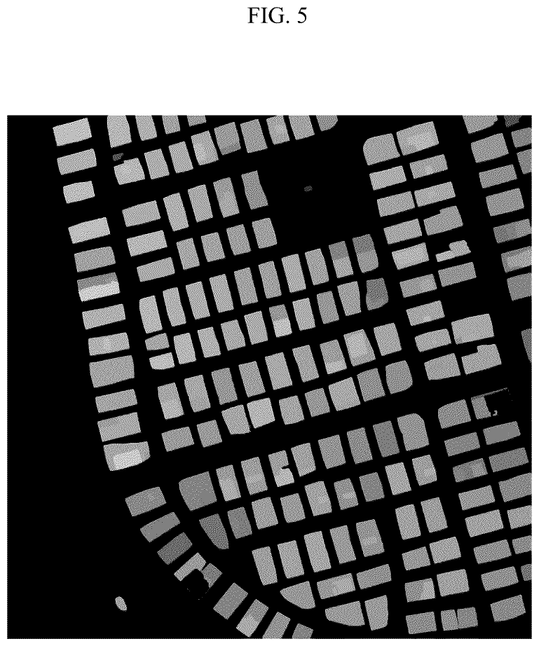

The processing unit 150 may be configured to generate the digital surface model for one or more individual objects included in the preprocessed satellite imagery by combining the digital surface model for the preprocessed satellite imagery with boundary information of the individual objects, and to generate a clustered object digital surface model (see FIG. 5) by integrating the digital surface models for the one or more individual objects (see S225).

In addition, the processing unit 150 may be configured to determine whether the corresponding object in the generated digital surface model is a building (see S230).

When the object is determined to be a building in S230, the processing unit 150 may be configured to mask a portion corresponding to a top surface of the building in the preprocessed satellite imagery using the vision transformer, and to perform plane fitting on the height values corresponding to the masked portion of the digital surface model for the building (see S235).

Specifically, the vision transformer used in the processing unit 150 may be trained to identify pixels corresponding to the top surface of the building in the image and may be configured to output a binary mask representing the identified pixels. Points corresponding to the masked top surface of the building may be extracted as three-dimensional coordinates, and a plane equation may be derived using the extracted set of three-dimensional points. For example, a general form of the plane equation is expressed as Ax+By+Cz+D=0. Then, plane fitting is performed by finding a best-fitting plane for the given set of points using the least squares method.

Then, the processing unit 150 may be configured to generate a reference digital surface model from the satellite imagery and to calibrate the height values of the clustered object digital surface model based on the height values of the reference digital surface model (see S240).

Specifically, since the satellite imagery is divided during the preprocessing stage, a plurality of clustered object digital surface models may be generated from a single satellite image. As the digital surface models are generated independently from one another, it is required to standardize the reference for height values across the models. To this end, the processing unit 150 may be configured to generate an undivided reference digital surface model from the satellite image and to calibrate the height values of clustered object digital surface models, which are generated from divided images, based on the undivided reference digital surface model.

On the other hand, when the object is not a building in S230, S240 is performed without performing S235.

The 3D mesh generation unit 160 may be configured to generate a 3D mesh by vectorizing the clustered object digital surface model (see S245).

For example, since the generated digital surface model is in a pixel-based format, the 3D mesh generation unit 160 may be configured to perform vectorization on the digital surface model to eliminate distortion, and to refine the boundaries of objects into curved or straight-line forms.

Specifically, vectorization may include applying hierarchical clustering to the digital surface model to subdivide it into clusters, and then performing vectorization on each cluster. After vectorizing each of the subdivided clusters, boundary lines may be simplified by replacing them with smoother continuous lines to eliminate the staircase effect of the boundary lines. Then, smoothing and corner preservation may be performed on the simplified boundary lines using the 4-point scheme algorithm, followed by curve adjustment, to vectorize the digital surface model.

Then, the 3D mesh generation unit 160 may be configured to determine whether the satellite imagery is in the GeoTIFF format (see S250).

When the satellite imagery is in the GeoTIFF format in S250, the 3D mesh generation unit 160 may be configured to generate the 3D mesh based on the coordinates of the satellite imagery (see S255).

The GeoTIFF format is an image file format that may include geographic information and allow coordinate system data to be stored together with image data. The coordinate system used may be based on universal transverse mercator (UTM) or world geodetic system 1984 (WGS84). The coordinate system information may be stored through metadata tags included in the GeoTIFF file and include a matrix used to convert pixel coordinates of the image into actual geographic coordinates. According to one embodiment of the present disclosure, the 3D mesh may be generated in actual metric units of the coordinate system by utilizing coordinate system information, such as UTM, included in the satellite imagery.

In addition, when the satellite imagery is determined to be in the GeoTIFF format in S250 and comprises a plurality of satellite images, the 3D mesh generation unit 160 may be configured to merge the generated plurality of 3D meshes based on the coordinates of the satellite images (see S255).

For example, when a plurality of satellite images in the GeoTIFF format, each corresponding to different geographic regions, are input, the 3D mesh generation unit 160 may be configured to utilize coordinate system information included in the satellite imagery to merge the 3D meshes generated from each image into a single 3D mesh based on the coordinates of the satellite imagery.

On the other hand, when the satellite imagery is determined not to be in the GeoTIFF format in S250, for example, when it is in PNG format, the 3D mesh generation unit 160 may be configured to generate a 3D mesh for each input satellite image based on the image size, using the lower-left corner of each image as the origin of the coordinate system (see S250).

The output unit 170 may be configured to output the generated 3D mesh in a predefined standardized format (see S260).

Preferably, the standardized format may conform to an OGC standard such as 3D Tiles or to another commonly used 3D model format.

The visualization unit 180 may be configured to determine whether the object is a building (see S265).

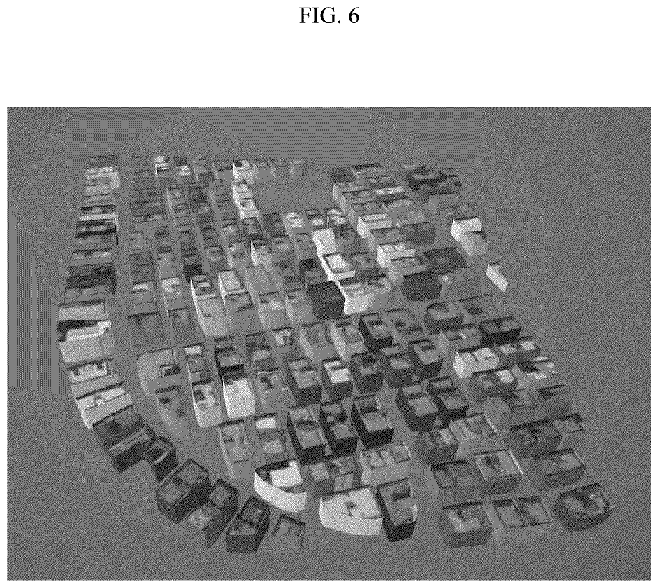

When the object is determined to be a building in S265, the visualization unit 180 may be configured to visualize the building in a 3D environment in a predefined standard format (see FIG. 6), wherein a top texture of the 3D mesh for the building is generated using satellite imagery of the building, and a side texture is generated by extracting color information from the top texture (see S270).

On the other hand, when the object is determined not to be a building in S265, the visualization is not performed.

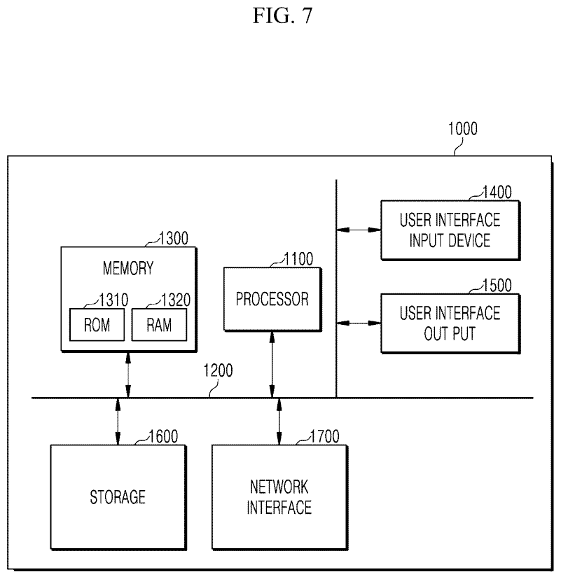

FIG. 7 is a diagram illustrating a computing system according to one embodiment of the present disclosure. One or more controllers, processors, or components described herein—such as the apparatus 100 for generating the standardized 3D object based on satellite imagery, the input unit 110, the preprocessing unit 120, the digital surface model generation unit 130, the object boundary information generation unit 140, the processing unit 150, the 3D mesh generation unit 160, the output unit 170, and the visualization unit 180—may be implemented by or within a computing system.

A computing system 1000 may include at least one processor 1100, a memory 1300, a user interface input device 1400, a user interface output device 1500, a storage device 1600, and a network interface 1700. All of these components may be connected to each other through a bus 1200. The processor 1100 may be a central processing unit (CPU) or a semiconductor device that executes instructions stored in the memory 1300 and/or the storage device 1600. The memory 1300 and the storage device 1600 may include various types of volatile or non-volatile storage media. For example, the memory 1300 may include a read only memory (ROM) 1310 and a random access memory (RAM) 1320.

Therefore, steps of the methods or algorithms described in connection with embodiments disclosed in this specification may be directly implemented in hardware, software modules, or a combination thereof executed by the processor 1100. The software modules may reside in storage media (i.e., the memory 1300 and/or the storage device 1600) such as RAM, flash memory, ROM, EPROM, EEPROM, registers, hard disks, removable disks, or CD-ROMs. An exemplary storage medium may be coupled to the processor 1100, and the processor 1100 may read information from, and write information to, the storage medium. Alternatively, the storage medium may be integrated with the processor 1100

The processor and the storage medium may reside within an application specific integrated circuit (ASIC). The ASIC may reside within a user terminal. Alternatively, the processor and storage medium may reside as individual components within the user terminal.

As used in the present disclosure (especially in the appended claims), the terms “a/an” and “the” include both singular and plural references, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to the present disclosure may be performed in an appropriate order unless a specific order is described or otherwise specified. That is, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those skilled in the art that various modifications, combinations, and alternations may be made depending on design conditions and factors within the scope of the appended claims or equivalents thereof.

The present disclosure described as above is not limited by the aspects described herein and accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

What is claimed is:

1. An apparatus for generating standardized 3D objects based on satellite imagery, the apparatus comprising:
a preprocessing unit configured to preprocess the satellite imagery by upscaling the satellite imagery using a generative adversarial network (GAN), and then resizing and dividing the upscaled satellite imagery;
a digital surface model generation unit configured to generate a digital surface model for the preprocessed satellite imagery by applying a vision transformer to the preprocessed satellite imagery;
an object boundary information generation unit configured to generate boundary information of individual objects included in the preprocessed satellite imagery using a convolutional neural network (CNN); and
a processing unit configured to generate digital surface models for one or more individual objects included in the preprocessed satellite imagery by combining the digital surface model for the preprocessed satellite imagery with the boundary information of individual objects, and to generate a clustered object digital surface model by integrating the digital surface models for the one or more individual objects.

2. The apparatus of claim 1, wherein the object boundary information generation unit is configured to generate boundary information of an object by performing polygon-based segmentation to extract the object from the satellite imagery.

3. The apparatus of claim 1, wherein the processing unit is configured to, when an object is a building, mask a portion corresponding to a top surface of the building in the preprocessed satellite imagery using the vision transformer, and perform plane fitting on height values corresponding to the masked portion of the digital surface model for the building.

4. The apparatus of claim 1, wherein the processing unit is configured to generate a reference digital surface model from the satellite imagery and calibrate height values of the clustered object digital surface model based on height values of the reference digital surface model.

5. The apparatus of claim 1, further comprising:
a 3D mesh generation unit configured to generate a 3D mesh by vectorizing the clustered object digital surface model; and
an output unit configured to output the 3D mesh in a predefined standardized format.

6. The apparatus of claim 5, wherein the 3D mesh generation unit is configured to generate the 3D mesh based on coordinates of the satellite imagery when the satellite imagery is in a GeoTIFF format.

7. The apparatus of claim 5, wherein the 3D mesh generation unit is configured to merge a plurality of generated 3D meshes based on coordinates of the satellite imagery when the satellite imagery is in a GeoTIFF format and comprises a plurality of satellite images.

8. The apparatus of claim 5, further comprising a visualization unit configured to visualize the 3D mesh, wherein, when the object is a building, a top surface texture of the building in the 3D mesh is generated using the satellite imagery of the building, and a side surface texture of the building is generated by extracting a color from the top surface texture.

9. A method for generating standardized 3D objects based on satellite imagery, the
method comprising:
preprocessing the satellite imagery by upscaling the satellite imagery using a generative adversarial network (GAN), and then resizing and dividing the upscaled satellite imagery;
generating a digital surface model for the preprocessed satellite imagery by applying a vision transformer to the preprocessed satellite imagery;
generating boundary information of individual objects included in the preprocessed satellite imagery using a convolutional neural network (CNN); and
generating digital surface models for one or more individual objects included in the preprocessed satellite imagery by combining the digital surface model for the preprocessed satellite imagery with the boundary information of individual objects, and generating a clustered object digital surface model by integrating the digital surface models for the one or more individual objects.

10. The method of claim 9, wherein the generating boundary information comprises generating boundary information of an object by performing polygon-based segmentation to extract the object from the satellite imagery.

11. The method of claim 9, wherein the generating the clustered object digital surface model comprises:
when the object is a building, masking a portion corresponding to a top surface of the building in the preprocessed satellite imagery using the vision transformer; and
performing plane fitting on height values corresponding to the masked portion of the digital surface model for the building.

12. The method of claim 9, wherein the generating the clustered object digital surface model comprises:
generating a reference digital surface model from the satellite imagery; and
calibrating height values of the clustered object digital surface model based on height values of the generated reference digital surface model.

13. The method of claim 9, further comprising:
generating a 3D mesh by vectorizing the clustered object digital surface model; and
outputting the 3D mesh in a predefined standardized format.

14. The method of claim 13, wherein the generating the 3D mesh comprises generating the 3D mesh based on coordinates of the satellite imagery when the satellite imagery is in a GeoTIFF format.

15. The method of claim 13, wherein the generating the 3D mesh comprises merging a plurality of generated 3D meshes based on coordinates of the satellite imagery when the satellite imagery is in a GeoTIFF format and comprises a plurality of satellite images.

16. The method of claim 13, further comprising visualizing the 3D mesh, wherein, when the object is a building, a top surface texture of the building in the 3D mesh is generated using the satellite imagery of the building, and a side surface texture of the building is generated by extracting a color from the top surface texture.

17. An apparatus for generating standardized 3D objects based on satellite imagery, the apparatus comprising:
a memory having instructions stored thereon; and
a processor configured to, when executing the instructions,
preprocess the satellite imagery by upscaling the satellite imagery using a generative adversarial network (GAN), and then resizing and dividing the upscaled satellite imagery;
generate a digital surface model for the preprocessed satellite imagery by applying a vision transformer to the preprocessed satellite imagery;
generate boundary information of individual objects included in the preprocessed satellite imagery using a convolutional neural network (CNN); and
generate digital surface models for one or more individual objects included in the preprocessed satellite imagery by combining the digital surface model for the preprocessed satellite imagery with the boundary information of individual objects, and generate a clustered object digital surface model by integrating the digital surface models for the one or more individual objects.

18. The apparatus of claim 17, wherein the processor is configured to generate boundary information of an object by performing polygon-based segmentation to extract the object from the satellite imagery, and the processor is configured to, when the object is a building, mask a portion corresponding to a top surface of the building in the preprocessed satellite imagery using the vision transformer, and perform plane fitting on height values corresponding to the masked portion of the digital surface model for the building.

19. The apparatus of claim 17, wherein the processor is configured to generate a reference digital surface model from the satellite imagery, and calibrate height values of the clustered object digital surface model based on height values of the generated reference digital surface model.

20. The apparatus of claim 17, wherein the processor is configured to:
vectorize the clustered object digital surface model to generate a 3D mesh;
output the 3D mesh in a predefined standardized format;
generate the 3D mesh based on coordinates of the satellite imagery when the satellite imagery is in a GeoTIFF format;
merge a plurality of generated 3D meshes based on coordinates of the satellite imagery when the satellite imagery is in GeoTIFF format and comprises a plurality of satellite images; and
visualize the 3D mesh, wherein, when the object is a building, a top surface texture of the building in the 3D mesh is generated using the satellite imagery of the building, and a side surface texture of the building is generated by extracting a color from the top surface texture.
